(19) United States
(12) Patent Application Publication
(10) Pub. No.: US 2023/0415118 A1
(43) Pub. Date: Dec. 28, 2023

(54) REFORMING REACTOR COMPRISING REFORMER TUBES WITH ENLARGED OUTER SURFACE AREA AND STRUCTURED CATALYST

(71) Applicant: L'Air Liguide Société Anonyme pour I'Etude et I'Exploitation des Procédés Georges Claude, Paris (FR)

(72) Inventors: Teja SCHMID-McGUINNESS, Frankfurt am Main (DE); Charline GALLIOT, Frankfurt am Main (DE); Amélie CHATTOT, Frankfurt am Main (DE); Marion STANKE, Jouy-en-Josas (FR); Diana TUDORACHE, Bures sur Yvette (FR)

(21) Appl. No.: 18/037,843

(22) PCT Filed: Nov. 17, 2021
(86) PCT No.: PCT/EP2021/025446

§ 371 Date: May 19, 2023

(30) Foreign Application Priority Data
Nov. 19, 2020 (EP) 20020546.6

(51) Int. Cl. B01J 19/18; B01J 15/00; B01J 19/00; C01B 3/38

(52) U.S. Cl. CPC B01J 19/1825; B01J 15/005; B01J 19/0013; B01J 19/185; C01B 3/384; B01J 2219/00157; C01B 2203/1023; C01B 2203/0811; C01B 2203/0233

(57) ABSTRACT

A reforming reactor for an endothermic process including a plurality of reformer tubes allowing a flow of hydrocarbons and at least one further fluid inside the tubes is provided. Wherein the reformer tubes contain in their interior a catalyst for the conversion of the hydrocarbons and the at least one further fluid to synthesis gas, and a means for heating the reformer tubes. Wherein at least a portion of the plurality of reformer tubes is provided with one or more elements for enlarging the outer surface area of a reformer tube, and the catalyst includes a structured catalyst. Also an endothermic process for the production of synthesis gas, including allowing a flow of hydrocarbons and at least one further fluid inside a plurality of reformer tubes, and heating the plurality of reformer tubes to convert said hydrocarbons and the at least one further fluid to synthesis gas.

### CROSS REFERENCE TO RELATED APPLICATIONS

This application is a 371 of International Application No. PCT/EP2021/025446, filed Nov. 17, 2021, which claims priority to European Patent Application No. 20020546.6, filed Nov. 19, 2020, the entire contents of which are incorporated herein by reference.

### TECHNICAL FIELD

The invention relates to a reforming reactor for an endothermic process, in particular a steam reformer for producing hydrogen. The invention further relates to an endothermic process to produce synthesis gas. The invention further relates to the use of the reforming reactor according to the invention for the production of hydrogen.

### BACKGROUND ART

A reforming reactor or reformer or reforming furnace is a reactor wherein hydrocarbon gas such as natural gas, mainly consisting of methane, and a further fluid, in particular steam, are converted to form a mixture of carbon monoxide and hydrogen in the presence of a catalyst. The mixture of the hydrocarbon gas and the further fluid are also referred to as process gas. The mixture of carbon monoxide and hydrogen is also referred to as synthesis gas or syngas. The catalyst is typically a metal-based catalyst, in particular nickel-based. When steam is used as the further fluid, the employed method of producing hydrogen is also referred to as steam methane reforming (SMR). The conversion reaction needs to be conducted at high temperatures, for example temperatures of at least 700° C. The heat necessary for the endothermic conversion of the process gas is regularly supplied by the combustion of fuel with an oxidant (e.g. air, oxygen enriched air or oxygen). The combustion is regularly performed by burners, placed in most configurations either on top (top fired reformer) or bottom (bottom fired reformer) of the reforming reactor. The process gas is heated in the reforming reactor by flowing it through catalyst filled reformer tubes either downwardly (in the case of a top fired reforming reactor) or upwardly (in the case of a bottom fired reforming reactor) towards the other end (bottom or top) of the reforming reactor. As the reformer tubes comprise in its interior the catalyst for the reforming reaction, they are often also referred to as catalyst tubes.

In the reforming reactor, the methane is reformed by the further fluid, in particular steam, at high temperatures of about between 700° C. and 980° C. and pressures between 10 and 40 bar in the reformer tubes. These operating conditions place certain demands on the reformer tubes. Specifically, the tubes are made of a refractory alloy which is resistant to high temperature oxidation and to creep. The operating conditions in the reforming reactor lead to a thermal profile with a significant gradient along the reformer tube between the first end, i.e. the process gas inlet and the second end, i.e. the process gas outlet, of the reformer tube. This temperature gradient is often from about 650/700° C. at the first end to about 900/950° C. at the second end of the reformer tube. In order to achieve such a temperature level, the reformers are designed with a wide variety of reformer tube arrangements. The heat is transferred to the catalyst through design of the tubes (cross section, length, thickness). A limiting step for the reforming reaction is the amount of heat supplied from the outer area of the tube, i.e. the combustion zone of the reforming reactor to the inside of the catalyst filled tube.

In other words, the main process limitation in reforming of methane is the external heat transfer from the combustion zone or heating zone of the reactor to the outer wall of the reformer tubes, and the internal heat transfer from the inner wall to the process gas flowing through the catalyst bed.

The addition of external structures such as fins to the reformer tubes helps to overcome the external heat transfer resistance from the combustion chamber to the reformer tubes, as disclosed in US 2017/0312721 A1. As a result, the tube temperature will increase, which is however detrimental to the lifetime of the tube.

In endothermic processes, structured catalysts are well known to yield multiple benefits compared to conventional catalyst pellets. Structured catalysts exhibit a higher heat transfer coefficient and geometric surface area (GSA) than catalyst pellets. Both lead to improved reaction kinetics and higher conversion rates for a given catalyst volume. Furthermore, structured catalysts exhibit a higher void fraction, which results in a lower pressure drop for a given mass flux.

For reforming of methane with steam or other fluids such as carbon dioxide, the use of a structured catalyst can enhance the internal heat transfer from the reformer tube inner wall to the process gas in two ways. First, the high intrinsic heat transfer coefficient of structured catalyst increases the amount of heat supplied to the process fluid and, therefore, the reaction rate and degree of conversion. Second, the low pressure drop of structured catalyst allows for higher flow rates. Since, the internal heat transfer is strongly driven by convection, it is thus of interest to increase the mass flux as much as possible.

An increase in mass flux also implies a reduction in residence time, with the consequence that the methane conversion could be affected. Structured catalyst exhibits a much higher available surface area for the reaction, however, which compensates for the reduced residence time at higher flow rates.

Similar to a setup with tubes with fins, a steam methane reformer using structured catalyst can yield benefits through a higher reformer efficiency to decrease the natural gas consumption, or by reducing the number of tubes to generate capital investment (CAPEX) savings, as disclosed in EP 0 025 308 B1.

In EP 0 305 203 A2, it is taught that in the steam methane reforming process, a low pressure drop and a high heat transfer coefficient represent the desired process conditions. It is further taught that the advantage of using structured catalyst rather than commercial catalyst pellets is that higher wall heat transfer is reached and therefore higher conversion rates without increasing the pressure drop. It is also taught that the highest degree of conversion for a given amount of catalyst is obtained when operating at the highest possible temperature. It follows that the operating temperature often approaches the upper limit temperature for the tube material, and that a uniform temperature distribution along the wall of the tube is desirable since it will permit the highest reforming temperature. Furthermore, the benefits of a structured catalyst layout are taught to achieve a uniform temperature distribution along the reformer tube.

EP 0 855 366 discloses various process parameters for the optimal use of a structured catalyst in steam methane reforming. In particular, it is taught to operate at high mass flow rates.

### SUMMARY

A way of measuring the energy efficiency of the reformer is to take the ratio of the duty which is used for the reforming reaction over the overall heat duty supplied to the reformer, which will henceforth be referred to as “reformer efficiency”.

A setup with tubes with fins yields the same reformer efficiency as a conventional design, albeit with fewer tubes, thereby generating capital investment (CAPEX) savings. However, various adverse effects are observed when adding external fins and decreasing the number of tubes. For a given reformer duty and fewer tubes, the maximum wall temperature increases, which may impact the lifetime of the tubes. The mass flux per tube increases, with the consequence that the pressure drop and approach to equilibrium increase.

For a given reformer size and number of tubes, a design with structured catalyst will yield only slight improvements in reformer efficiency over a conventional design with catalyst pellets.

It is therefore an object of the present invention to provide a setup for a reforming reactor with improved characteristics.

In particular, an object of the present invention is to provide a reforming reactor with a minimum number of reforming tubes in the reformer, the reforming reactor exhibiting a high reformer efficiency at the same time.

It is a further object of the present invention to provide a reforming reactor with a minimum number of reforming tubes in the reformer, the reforming reactor exhibiting a high methane conversion rate at the same time.

It is a further object of the present invention to provide a reforming reactor with a minimum number of reforming tubes in the reformer, the reforming reactor comprising reformer tubes with prolonged lifetime at the same time, by minimizing the occurrence of temperature peaks at the walls of the reformer tubes.

A contribution to the at least partial solution of at least one of the above mentioned objects is provided by the subject-matter of the independent claims. The dependent claims provide preferred embodiments which contribute to the at least partial solution of at least one of the objects. Preferred embodiments of elements of a category according to the invention shall, if applicable, also be preferred for components of same or corresponding elements of a respective other category according to the invention.

The terms “having”, “comprising” or “containing” etc. do not exclude the possibility that further elements, ingredients etc. may be comprised. The indefinite article “a” or “an” does not exclude that a plurality may be present.

In general, at least one of the underlying problems is at least partially solved by a reforming reactor for an endothermic process, the reforming reactor comprising
a plurality of reformer tubes allowing a flow of hydrocarbons and at least one further fluid inside the tubes, wherein
the reformer tubes contain in their interior a catalyst for the conversion of said hydrocarbons and said at least one further fluid to synthesis gas;
means for heating the reformer tubes;
characterized in that
at least a portion of the plurality of reformer tubes is provided with one or more elements for enlarging the outer surface area of a reformer tube, and
the catalyst comprises a structured catalyst.

The combination of both elements for enlarging the outer surface area of a reformer tube and a structured catalyst in the interior of the reformer tubes yields synergies in terms of hydrocarbon (e.g. natural gas or methane) conversion, hydrocarbon (e.g. natural gas or methane) consumption, reformer efficiency, and the possibility to reduce the number of reformer tubes in the reforming reactor, allowing for a more compact and efficient reforming reactor than with either using elements for enlarging the outer surface of a reformer tube only or using structured catalyst in the interior of the reformer tubes only.

The reformer tubes are also referred to as the reactors of the reforming reactor. In one embodiment, the means for heating the reformer tubes are heating means for firing the reformer tubes.

In one embodiment, the reformer tubes are vertically arranged.

In one embodiment, the reforming reactor is a reforming furnace. In one embodiment, the reforming reactor is a steam methane reformer.

In one embodiment, the hydrocarbons comprise methane, preferably consist mainly of methane.

In one embodiment, the at least one further fluid is steam. In one embodiment, methane and steam are converted to yield syngas according to the endothermic reaction

CH₄+H₂O [symbol] CO+3H₂

which is also referred to as steam methane reforming.

In one embodiment, the at least one further fluid is carbon dioxide. In one embodiment, methane and carbon dioxide are converted to yield syngas according to the endothermic reaction

CO₂+CH₄ [symbol] 2H₂+2CO

which is also referred to as carbon dioxide reforming or dry reforming.

In one embodiment, the heating means comprise burners for firing the reformer tubes. In one embodiment, the burners are arranged at the top of the reforming reactor and fire the tubes with flames directed downwards to the bottom of the reforming reactor. In one embodiment, the burners are arranged at the bottom of the reforming reactor and fire the tubes with flames directed upwards to the top of the reforming reactor.

In one embodiment, the flow of the hydrocarbons and the at least one further fluid is downwards. In this particular embodiment, the burners are arranged at the top of the reforming reactor, firing the tubes with flames directed downwards to the bottom of the reforming reactor.

In one further embodiment, the flow of the hydrocarbons and the at least one further fluid is upwards. In this particular embodiment, the burners are arranged at the bottom of the reforming reactor, firing the tubes with flames directed upwards to the top of the reforming reactor.

In one embodiment, the reforming reactor comprises alternating lanes of burners and of reformer tubes.

In one embodiment, each lane of burners is positioned in between two lanes of reformer tubes or in between a lane of reformer tubes and a side wall of the reforming reactor.

In one embodiment, if the at least one further fluid comprises steam, the molar ratio of steam to carbon is between 1 and 3.5.

In one embodiment, the heating means comprise a hot flue gas and/or a hot product gas for firing the reformer tubes. In one embodiment, the hot product gas is a product gas from an autothermal reformer (ATR).

In one embodiment, the hydrocarbon conversion in the reforming reactor is at least 50%, preferably at least 70%, or at least 75%, or at least 80%, or at least 90%, or at least 95%.

In one embodiment, the reforming reactor is configured such that a normalized space velocity at an inlet of a reformer tube is from 1 Nm³/(s*m³) to 5 Nm³/(s*m³), preferably from 1 Nm³/(s*m³) to 3 Nm³/(s*m³).

In one embodiment and more preferred, the reforming reactor is configured such that a normalized space velocity at an inlet of a reformer tube is from 1.9 Nm³/(s*m³) to 3.2 Nm³/(s*m³), preferably from 2.0 Nm³/(s*m³) to 3.0 Nm³/(s*m³).

The normalized space velocity is defined as the normalized volume flow rate at (zero degree Celsius) and 1 atmosphere, divided by the total volume of the reformer tube (reactor) filled with catalyst and including the space used by the catalyst. In other words, the volume of the reformer tube filled with catalyst without subtracting the volume occupied by the structured catalyst is considered. The volume flow rate is thus defined by the superficial velocity multiplied by the tube cross-section. Hence, the normalized space velocity can be set by adjusting the volume flow rate of hydrocarbons and at least one further fluid, in particular the flow of natural gas and steam at the inlet of the respective reformer tube. The total volume of the reformer tube (reactor) is known. In one embodiment, the normalized space velocity is the same or essentially the same for each one of the reformer tubes (reactors) of the reforming reactor.

There is a direct relationship between the (normalized) space velocity and the pressure drop of the reforming reactor. The higher the space velocity, the higher the pressure drop. An important key performance indicator (KPI) of a reforming reactor is the quotient of reformer efficiency and pressure drop. Thereby, the reformer efficiency is equivalent to the maximum heat transfer from the heating means to the reformer tubes and the structured catalyst. When the space velocity increases, the pressure drop increases, so the quotient of reformer efficiency and pressure drop decreases at constant reformer efficiency. On the other hand, the reforming reactor should be as compact as possible with the lowest possible number of tubes. Hence, another important key performance indicator is the quotient of reformer efficiency and the number of reformer tubes in the reforming reactor. The lower the number of tubes, the higher the quotient of reformer efficiency and number of tubes at constant reformer efficiency.

Simulations have surprisingly shown that at higher (normalized) space velocities, in particular normalized space velocities from 1.9 Nm³/(s*m³) to 3.2 Nm³/(s*m³), preferably from 2.0 Nm³/(s*m³) to 3.0 Nm³/(s*m³), the number of tubes in the reforming reactor can drastically be reduced compared to lower (normalized) space velocities, without losing significantly in reformer efficiency or in hydrocarbon conversion. Although the KPI defined by the quotient of reformer efficiency and pressure drop decreases due to the higher unit pressure drop, this effect is overcompensated by the fact that the KPI defined by the quotient of reformer efficiency and number of reformer tubes increases such that it is significantly higher than at lower space velocities. This opens up the possibility of significantly reducing the number of reformer tubes in the reformer reactor, which firstly enables the construction of a significantly more compact reformer and secondly saves investment costs. Finally, the maintenance costs are also reduced, since the reformer tubes are subject to material fatigue after a certain operating time.

Reducing the number of reformer tubes in the reforming reactor is difficult, as not only the space velocity and the pressure drop increases, but also the heat exchange area diminishes and the maximum tube wall temperature increases. However, simulations have shown that for the aforementioned normalized space velocity ranges, the maximum tube wall temperature can be maintained at the same value as for lower normalized space velocities without compromising on the reformer efficiency, in particular compared to normalized space velocities below 1.9 Nm³/(s*m³) or 2.0 Nm³/(s*m³).

In one embodiment, the means for heating the reformer tubes are burners, and
the reformer tubes are arranged in rows within the reforming reactor, each row of reformer tubes thereby defining a reformer tube row, and the burners are arranged in rows within the reforming reactor, wherein a plurality of inner burners is arranged between and parallel to two reformer tube rows, thereby defining an inner burner row, and a plurality of outer burners is arranged between and parallel to a reformer tube row and a reforming reactor wall, thereby defining an outer burner row.

In one embodiment, the elements for enlarging the outer surface area of a reformer tube are distributed heterogeneously along the circumference of a reformer tube, and the circumferential surface of a reformer tube has a first partial surface and a second partial surface, wherein the first partial surface corresponds to the surface with which reformer tubes within a reformer tube row face one another, and the second partial surface corresponds to the surface with which reformer tubes face a row of inner burners or a row of outer burners, and wherein the number of elements for enlarging the outer surface of a reformer tube arranged on the first partial surface is larger than the number of elements for enlarging the outer surface of a reformer tube arranged on the second partial surface.

According to this measure, the elements for enlarging the outer surface of a reformer tube, in particular fins, are distributed heterogeneously along the circumference of the reformer tube in the sense that they are primarily positioned in the region where the reformer tubes face each other, which is where the tube wall temperature is the lowest, and away from the portion of the tubes facing the burners of an inner burner row or an outer burner row.

Compared to a homogenous arrangement of the elements for enlarging the outer surface of a reformer tube, the heat flux is thus significantly increased whilst the maximum tube wall temperature can be essentially kept constant. The reformer efficiency is thereby increased. Furthermore, due to this measure, the reformer tube thickness does not need to be increased and the reforming temperature does not need to be decreased, both of which would be detrimental to the costs and efficiency of the reformer.

According to one embodiment, the first partial surface corresponds to half of the total circumferential surface of a reformer tube. In particular, said half of the total circumferential surface is divided into two sub-surfaces, each of the sub-surfaces corresponding to a quarter of the total circumferential area of the reformer tube. In one further embodiment, each of the two sub-surfaces of the first partial surface is facing a neighbouring reformer tube of the same reformer tube row. In particular, the two sub-surfaces of the first partial surface lie opposite each other on the same reformer tube.

According to one embodiment, the second partial surface corresponds to half of the total circumferential surface of a reformer tube. In particular, said half of the total circumferential surface is divided into two sub-surfaces, each of the sub-surfaces corresponding to a quarter of the total circumferential area of the reformer tube. In one further embodiment, each of the two sub-surfaces of the second partial surface is facing a burner of a neighbouring inner burner row and/or outer burner row. In particular, the two sub-surfaces of the second partial surface lie opposite each other on the same reformer tube.

In one embodiment, the structured catalyst is selected from the group comprising monoliths, open cell foams, stacked wire meshes and structured packing.

In one embodiment, the structured catalyst is selected as a structured packing type catalyst. This type of structured catalyst yields good heat transfer and pressure drop characteristics, and can be designed to preferentially direct the flow towards the inner surface of the reformer tube wall.

In one embodiment, the structured catalyst comprises a supporting structure and a catalytic active species fixed to said supporting structure.

In one embodiment, the flowed-through area of the reformer tube comprises a circular cross-section or an annular cross-section.

In one preferred embodiment, the cross-section of the flowed-through area of a reformer tube has a circular cross-section. Such reformer tubes are only flowed through in one direction, either from bottom to top or from top to bottom by the flow of hydrocarbons and the at least one further fluid.

In one further embodiment, the cross-section of the flowed-through area of a reformer tube has an annular cross-section.

According to this embodiment, the reformer tube has at least one additional wall, in particular a circular wall, in the cross section, which does not extend over the entire length of the reformer tube. This configuration may also be referred to as tube-in-tube configuration with an inner tube and outer tube, wherein the outer tube wall is adjacent to the firing chamber or heating chamber of the reforming reactor. The tube-in-tube reformer tube has the process gas (hydrocarbons and at least one further fluid) inlet and product gas (syngas) outlet on the same side. In one embodiment, the outer annulus (the area between the outer tube wall and the inner tube wall) of the tube-in-tube reformer tube contains the structured catalyst and the inner tube is free of catalyst. Thereby, the inner tube is used to exchange heat of the syngas with the gas that is reacting in the outer annulus of the tube-in-tube reformer tube. According to this embodiment, the hydrocarbons and the at least one further fluid (process gas) respectively the product gas (syngas) flow through the reformer tube in two different directions. By the additional wall or tube-in-tube configuration, the reformer tube is divided into a flowed through outer area and a flowed through inner area. Preferably, the process gas comprising hydrocarbons and the at least one further fluid first flows through the reformer tube on the outer area from a first end of the reformer tube to a second end of the reformer tube, thereby reacting, by contacting the structured catalyst, to syngas. Then the syngas flows through the inner area from the second end of the reformer tube to the first end of the reformer tube, thereby exchanging heat with the reacting process gas in the outer tube.

Said tube-in-tube configuration is advantageous for zero or low steam export reforming units, where the heat of the produced syngas is used for heating the highly endothermic reforming reaction, rather than to generate (export) steam.

In one embodiment, the inner tube of the tube-in-tube reformer tube includes an internal rod. Thereby, the velocity of the reformed syngas in the inner tube is increased.

In one embodiment, the structured catalyst comprises one type of structured catalyst or a plurality of structured catalysts within the same reformer tube.

In one embodiment, an element for enlarging the outer surface area of the reformer tube is made from the same material as the reformer tube.

In one embodiment, an element for enlarging the outer surface of the reformer tube is substance bonded to the material of the reformer tube. In one embodiment, the element for enlarging the outer surface of the reformer tube is welded to the reformer tube.

In one embodiment, an element for enlarging the outer surface area of the reformer tube is selected from at least one element of the group comprising fins, blades, rips, slats or lamellae.

The element for enlarging the outer surface area of a reformer tube may be selected from any element known to the skilled person which extends the outer surface of the reformer tube. Examples for such surface extending elements are fins, blades, rips, slats and lamellae or combinations thereof.

According to a preferred embodiment, the element for enlarging the outer surface area of the reformer tube is a fin.

In one embodiment, an element for enlarging the outer surface area of the reformer tube extends in the longitudinal direction of the reformer tube.

In one embodiment, a fin, blade, rip, slat or lamella extends in longitudinal direction of the reformer tube. In one preferred embodiment, reformer tubes are equipped with fins extending in the longitudinal direction of the reformer tube.

Computational Fluid Dynamics (CFD) simulations have shown that longitudinally extending elements are preferred over circumferentially extending elements. For example, in the case of a steam methane reformer equipped with burners as heating means, the transfer of heat from the combustion chamber to the reformer tubes is improved in comparison to the case of circumferentially extending elements.

Nevertheless, it can be advantageous for certain configurations of the reforming reactor that a part of the elements for enlarging the outer surface area of a reformer tube extend in the longitudinal direction of the reformer tube and a part of the elements for enlarging the outer surface of a reformer tube extend in the circumferential direction of the reformer tube.

According to a further embodiment, elements for enlarging the outer surface area of the reformer tube extending in the longitudinal direction may have a circumferential component.

In one embodiment an element for enlarging the outer surface area of a reformer tube extending in the longitudinal direction of a reformer tube, in particular a fin, has the shape of a plate, the plate having a length (l), width (w) and thickness (t). The plate extends in longitudinal direction of a reformer tube along the length (l) of the plate. The plate is connected to the reformer tube via one of the side surfaces which results from the length (l) and thickness (t) of the plate. The plate extends from the mounting surface on the reformer tube outwards along the width (w) of the plate. The cross-sectional area of the plate is defined by the width (w) and thickness (t). In one embodiment, the cross-sectional area of the plate is rectangular. According to further embodiments, the cross-sectional area of the plate may comprise shapes such as a parallelogram, a triangle and a trapezium.

In one embodiment, the plate shaped fin comprises a thickness (t) comprised between 1 and 30 mm, and a width (w) comprised between 3 mm and 100 mm.

In one embodiment, an element for enlarging the outer surface of a reformer tube comprises corrugations and/or bevels.

In one embodiment, the number of elements for enlarging the outer surface area of the reformer tube is larger in the area of the inlet of the reformer tube than in the area of the outlet of the reformer tube.

Preferably, the number of elements with essentially same or same surface area or same area enlarging effect is larger in the area of the inlet of the reformer tube than in the area of the outlet of the reformer tube.

This is in particular preferred if the cross-section of the flowed-through area of the reformer tube has a circular cross-section. Such reformer tubes are only flowed through in one direction, either from bottom to top or from top to bottom by the flow of hydrocarbons and the at least one further fluid. In the longitudinal direction of such reformer tubes, the reforming gas temperature is lower in the area of the inlet of the reformer tube and higher in the area of the outlet of the reformer tube, as the process gas mixture heats up in the course of the synthesis gas forming reaction. Thus, preferably the number of elements for enlarging the outer surface area of a reformer tube is larger at the inlet area of the reformer tube, as the heat transfer from the combustion chamber to the reformer tubes shall be improved preferably in colder areas of the reformer tube.

In one embodiment, the number of elements for enlarging the outer surface area of the reformer tube on the circumference at any height along the reformer tube is comprised between 0 (zero) and 50.

In one embodiment, the elements for enlarging the outer surface area of the reformer tube, whose number on the circumference at any height along the reformer tube is comprised between 0 (zero) and 50, are fins.

Preferably, the number of elements for enlarging the outer surface area of the reformer tube extending in the longitudinal direction of the reformer tube on the circumference at any height along the reformer tube is comprised between 0 (zero) and 50. So if the elements, preferably the fins, are extending longitudinally, at any longitudinal position along the tube, there are between zero and fifty elements distributed along the circumference.

In one embodiment, the normalized space velocity at the reformer tube inlet is from 1 Nm³/(s*m³) to 5 Nm³/(s*m³), preferably from 1.0 Nm³/(s*m³) to 3.0 Nm³/(s*m³), more preferred from 2.0 Nm³/(s*m³) to 3.0 Nm³/(s*m³) and further preferred from 2.1 Nm³/(s*m³) to 2.7 Nm³/(s*m³).

In one embodiment, the heat flux from an outer part of the reformer tubes to an inner part of the reformer tubes is from 50 kW/m² to 200 kW/m² on average along the length of the tube.

In one embodiment, the reformer tube provided with one element or a plurality of elements for enlarging the outer surface area of said reformer tube comprises an outside surface area which is at least 10% to 60% higher than a comparable reformer tube without elements for enlarging the outer surface area, preferably 15 to 60% higher, more preferably 15 to 50% higher.

Furthermore, at least one of the underlying problems is at least partially solved by an endothermic process for the production of synthesis gas,
comprising the process steps of
allowing a flow of hydrocarbons and at least one further fluid inside a plurality of reformer tubes, whereby
the reformer tubes contain in their interior a catalyst for the conversion of said hydrocarbons and said at least one further fluid to synthesis gas;
heating the plurality of reformer tubes to convert said hydrocarbons and said at least one further fluid to synthesis gas;
characterized in that
at least a portion of the plurality of reformer tubes is provided with one or more elements for enlarging the outer surface area of a reformer tube, and
the catalyst comprises a structured catalyst.

According to one embodiment of the process, a normalized space velocity at an inlet of a reformer tube is from 1 Nm³/(s*m³) to 5 Nm³/(s*m³), preferably from 1 Nm³/(s*m³) to 3 Nm³/(s*m³).

In one embodiment of the process and more preferred, a normalized space velocity at an inlet of a reformer tube is from 1.9 Nm³/(s*m³) to 3.2 Nm³/(s*m³), preferably from 2.0 Nm³/(s*m³) to 3.0 Nm³/(s*m³).

Furthermore, at least one of the underlying problems is at least partially solved by a use of a reforming reactor according to at least one embodiment of the aforementioned reformer reactor for the production of hydrogen.

In one embodiment, by use of aforementioned reforming reactor, the exported steam of the reforming reactor comprises a quantity from 0 to 1.5 kg steam per Nm³ produced hydrogen.

### Structured Catalyst

In the following, typical properties and designs for structured catalysts are described, which do not constitute a limitation of the invention.

Structured catalyst may be defined, without limiting the invention, as any catalytically active packing formed by a plurality of channels in order to guide the flow. It can be formed by any kind of material. The channels can be of different shape, and may be designed in such a way to direct the flow along a preferred path. The channels might be parallel to each other or not.

In principle, three basic kinds of structured catalysts can be distinguished.

First, monolithic catalysts (e.g. honeycomb-structured catalysts, open cell foams, stacked wire meshes), in the form of continuous unitary structures that contain small passages. The catalytically active material is present on or inside the walls of these passages. In the former case, a ceramic or metallic support is coated with a layer of material in which active ingredients are dispersed.

Second, membrane catalysts which are structures with permeable walls between passages. The membrane walls exhibit selectivity in transport rates for the various components present. A slower radial mass transport can occur, driven by diffusion or by combined solution/diffusion mechanisms in the permeable walls.

Third, arranged catalysts. Also particulate catalysts arranged in arrays belong to this class of structured catalysts. Another group of arranged catalysts are structured catalysts derived from structured packings for distillation and absorption columns and static mixers. These are structures consisting of superimposed sheets, possibly corrugated before stacking. The sheets are covered by an appropriate catalyst support in which active ingredients are incorporated. The structure is an open cross-flow structure characterized by intensive radial mixing.

Preferably, the structured catalysts in the interior of the reformer tube comprises structures of large void fraction ranging from 0.7 to more than 0.9. This is significantly higher than a void volume of about 0.5 in packed bed catalysts. The path the hydrocarbon fluid and the at least one further fluid follow in the structured catalyst can be less twisted (e.g., straight channels in monoliths) than that in conventional packed bed catalysts. Furthermore, the structured catalyst filled reformer tubes can be operated in a different flow regime. For single-phase flow, the structured catalyst setup can be designed such that the flow is at a lower Reynolds number, and in some cases even that the flow regime is laminar, with the consequence that the eddies characteristic of a packed beds catalyst are absent. For this and further reasons, the pressure drop in a reformer tube filled with structured catalysts can be significantly lower than that in a comparable reformer tube with packed bed catalyst of particles. In an example, the pressure drop in a reformer tube filled with monolithic structured catalyst can be up to two orders of magnitude lower than that in a comparable reformer tube with packed bed catalyst.

Catalytic species may either be incorporated into a thin layer of a porous catalyst support deposited on the structured elements or into the thin elements themselves. The short diffusion distance inside the thin layer of the structured catalysts results in higher catalyst utilization and can contribute to an improvement of selectivity for processes controlled by mass transfer within the catalytic layer. In contrast to conventional packed-bed catalysts, the thickness of the catalytic layer in monolithic reactors can be significantly reduced with no penalty paid for the increase in pressure drop.

### BRIEF DESCRIPTION OF THE DRAWINGS

The invention will now be detailed by way of exemplary embodiments and examples with reference to the attached drawings. Unless otherwise stated, the drawings are not to scale. In the figures and the accompanying description, equivalent elements are each provided with the same reference marks.

In the drawings:

FIG. 1 depicts a reformer tube 100 equipped with one fin for enlarging the outer surface area of a reformer tube,

FIG. 2 depicts a reformer tube 200 with tube-in-tube configuration, comprising an outer tube and an inner tube,

FIG. 3 depicts a reformer tube 200 with tube-in-tube configuration, comprising an outer tube and an inner tube, wherein the inner tube comprises a rod,

FIG. 4 a top view of a section 400 of a reforming reactor, showing two reformer tubes of one reformer tube row and three burners of each burner row adjacent to the reformer tube row.

### DETAILED DESCRIPTION OF THE PREFERRED EMBODIMENTS

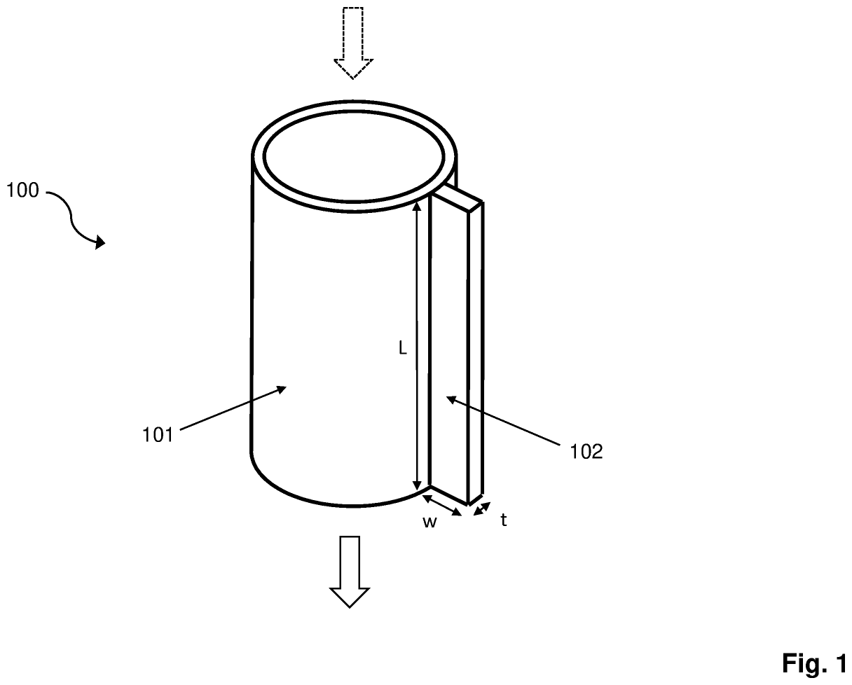

FIG. 1 depicts a reformer tube 100 equipped with one fin for enlarging the outer surface area of a reformer tube. However, only one fin is shown for the sake of simplification. For most of the cases, the reformer tube 100 will be equipped with a plurality of fins.

The reformer tube 100 comprises a reformer tube 101 to which a fin 102 is attached by welding. Both the reformer tube and the fin are made of a refractory alloy, preferably the same refractory alloy. The reformer tube 100 is also equipped with a structured catalyst in its interior (not shown). The fin 102 has the shape of a plate with rectangular cross-sectional shape having a length (l), a width (w) and a thickness (t). The fin 102 extends in longitudinal direction over the entire length (l) of the reformer tube 101 to which it is attached. The reformer tube 100 is flown through from top to bottom by process gas (dotted arrow), which contains mainly methane as hydrocarbon component and steam as a further fluid. The reformer tube 100 is heated from the outside with burners (not shown). The process gas is converted to hydrogen and carbon monoxide (synthesis gas) at the structured catalyst (solid arrow). Carbon dioxide is usually produced as a by-product.

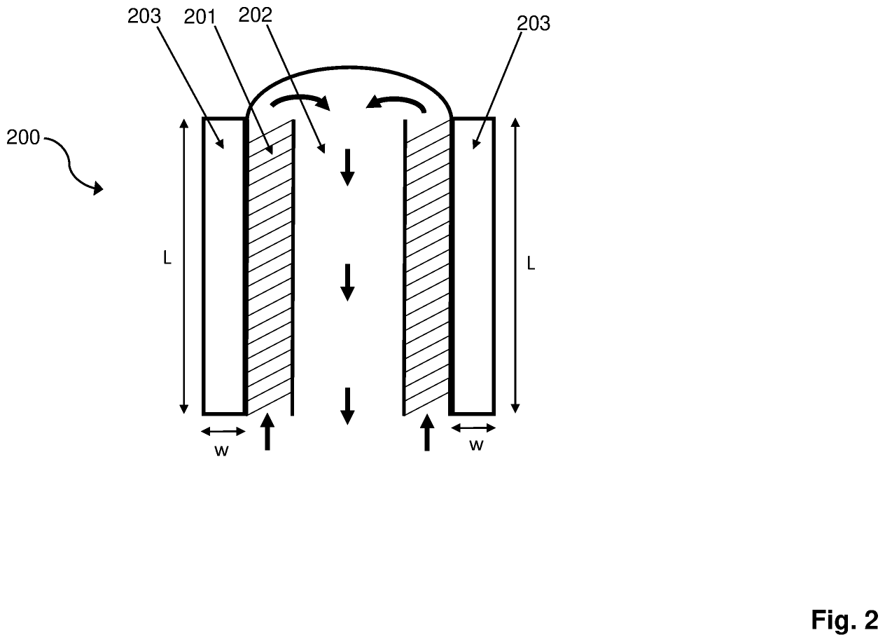

FIG. 2 depicts a longitudinal section of a reformer tube 200 with tube-in-tube configuration, comprising an outer tube 201, an inner tube 202 and fins 203 as elements for enlarging the outer surface of the outer reformer tube 201.

The reformer tube 200 as shown in FIG. 2 has a so-called tube-in-tube configuration, where this configuration is defined by an outer tube 201 and a tube 202 inside the outer tube. Between the wall of the outer tube 201 and the inner tube 202 is a structured catalyst (indicated by the hatched area). The inner tube 202 is free of catalyst, i.e. free to flow through. The flow to the reformer tube 200 is from below, whereby the process gas containing methane and steam first flows through the outer, catalyst-filled outer tube 201. The reformer tube 200 is heated from the outside with burners (not shown). Thereby, methane and steam are converted into synthesis gas at the catalyst arranged in the outer tube 201 of reformer tube 200. The reformer tube 200 is closed at the top, whereby the synthesis gas then inevitably flows through the inner tube 202 from top to bottom and exits the reformer tube 200 on the same side where the process gas enters the reformer tube. The synthesis gas flowing downwards heats the endothermic reaction taking place in the outer tube 201 and cools itself in the process.

The reformer tube 200 comprises a plurality of fins 203 as surface enlarging elements for the outer reformer tube 201. As a longitudinal section of reformer tube 200 is depicted in FIG. 2, only two of the plurality of fins are shown. The fins 203 are attached to outer reformer tube 201 by welding. The reformer outer tube 201, the reformer inner tube 202 and the fins 203 are made of a refractory alloy, preferably are made of the same refractory alloy. The fins 203 have the shape of a plate with rectangular cross-sectional shape having a length (l), a width (w) and a thickness (t). In terms of the thickness (t), the fins 203 extend perpendicular to the drawing plane of FIG. 2. The fins 203 extend in longitudinal direction over the entire length (l) of the outer reformer tube 201 to which they are attached.

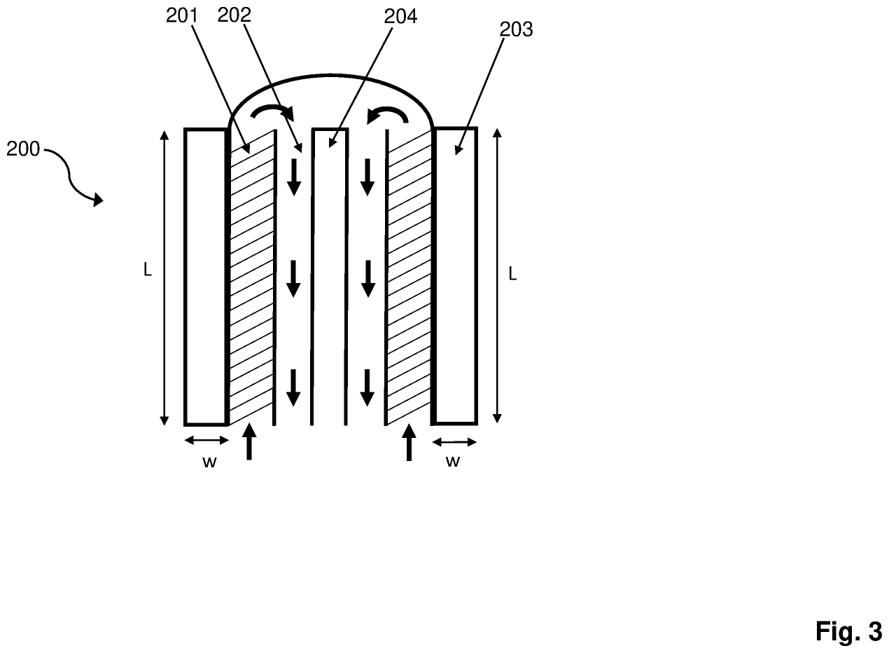

FIG. 3 depicts a longitudinal section of a reformer tube 200 with tube-in-tube configuration, comprising an outer tube 201, an inner tube 202, fins 203 as elements for enlarging the outer surface of the outer reformer tube 201 and a rod 204 arranged within the inner tube 202. By the rod 204, the velocity of the reformed syngas in the inner tube is increased. Otherwise, the same explanations apply to FIG. 3 as to FIG. 2.

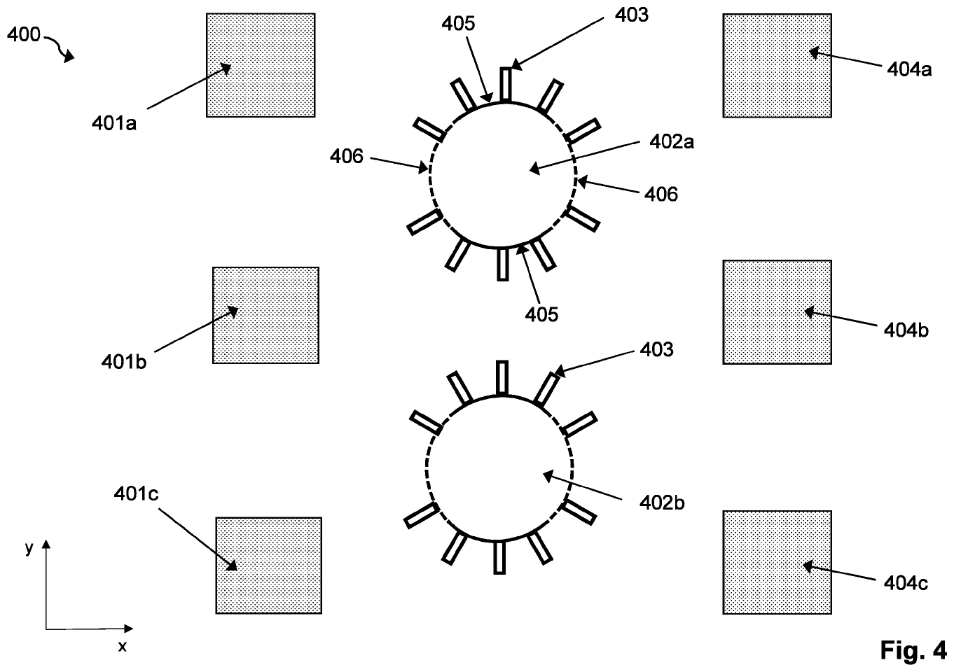

FIG. 4 depicts a top view of a section 400 of a reforming reactor (or reforming furnace), showing two reformer tubes 402a and 402b forming a part of a reformer tube row. Further depicted are three burners 401a, 401b and 401c, forming a part of an inner burner row and three burners 404a, 404b and 404c, forming a part of a further inner burner row. Each of the inner burner rows is adjacent to the reformer tube row. The reformer tubes 402a and 402b are each equipped with ten fins 403 and filled with structured catalyst (not shown).

In a reforming reactor, of which a section is shown in FIG. 4, the inner burner row with burners 401a, 401b and 401c, the inner burner row with burners 404a, 404b and 404c, and the reformer tube row with reformer tube 402a and 402b extend in the y-direction of the drawing plane. Reformer tube rows and inner or outer burner rows alternate in the x-direction of the drawing plane. Inner burner rows are arranged between two reformer tube rows and outer burner rows (not shown) are arranged between an outer wall of the reforming reactor and a reformer tube row. Due to this arrangement, one reformer tube row is always fired by the burners of two burner rows.

The fins 403 are distributed heterogeneously along the circumference of the reformer tubes 402a and 402b. The circumferential surface of the reformer tube 402a comprises a first partial (circumferential) surface 405 and a second partial (circumferential) surface 406. The first partial surface 405 is divided into two sub-surfaces (indicated by solid lines). The two sub-surfaces of the first partial surface 405 each face a neighbouring reformer tube (reformer tube 402b for the “lower” sub-surface and reformer tube not shown for the “upper” sub-surface). The second partial surface 406 is divided into two sub-surfaces (indicated by dotted lines). The two sub-surfaces of the second partial surface 406 each face a neighbouring burner tube row (the “left” sub-surface faces the inner burner row with burners 401a, 401b and 401c; the “right” sub-surface faces the inner burner row with burners 404a, 404b and 404c). Six fins 403 in total are arranged on the first partial surface 405, and only four fins in total are arranged on the second partial surface 406. So the number of fins arranged on the first partial surface, facing another reformer tube, is larger than the number of fins on the second partial surface, facing the burners of the inner burner rows.

The reformer tubes 402a and 402b “see” an increased temperature in particular on the side facing the burners, i.e. the second partial surface 406. In this area, the external heat transfer from the combustion zone of the reforming reactor to the outer wall surface of the reformer tubes 402a and 402b and the internal heat transfer from the inner wall surface of the reformer tubes 402a and 402b to the structured catalyst is favoured. As a consequence, a lower number of fins 403 is attached to the reformer tubes 402a and 402b in the areas facing the burners, i.e. the areas referred to as the second partial (circumferential) surface 406 of a reformer tube 402a or 402b. On the sides of a reformer tube 402a or 402b, where the reformer tubes face each other, referred to as the first partial (circumferential) surface 405, the aforementioned heat transfer is impaired, resulting in lower temperatures. To improve the heat transfer in those areas of the reformer tubes 402a and 402b, the number of fins 403 is larger there.

### EXAMPLES

Further features and embodiments of the invention are described in the following examples. The examples do not represent a limitation of the claimed invention.

For the examples of tables 1a, 1b and 2 (single pass reformer tubes), a Catacel™ structured catalyst obtained from Johnson Matthey was used. The characteristics of the catalyst (pressure drop, heat transfer coefficient) were modelled in a proprietary reforming simulation environment based on supplier data and the results of test campaigns on steam methane reformers that were equipped with said catalyst.

For the examples of Table 3 (tube-in-tube reformer tubes), a ZoneFlow™ structured catalyst obtained from Zoneflow Reactor Technologies was used. The characteristics of this catalyst were again modelled in a proprietary reforming simulation environment based on supplier data and tests on pilot plants.

For the overall steam methane reforming (SMR) simulation, Aspen™Plus™, a process simulation software package from aspentech, was used. The proprietary simulation tool mentioned above solved the mass, momentum and energy conservation equations in the combustion chamber and reforming tubes. It uses inputs from the global SMR simulation in AspenPlus, and its results are fed back to Aspen in an iterative process until the simulation has converged.

Fluent™ from ansys was used to model the impact of fins on the reformer tubes. A simplified model of the fins was inferred from the CFD simulations with Fluent, which was then integrated in the solver of the proprietary simulation tool.

The width (w) and thickness (t) of the fins was selected such that they would yield 90% of the heat flux (or heat transfer) gains that a fin with infinite width would produce.

The fins were not positioned in the 1^{st} meter of length of a reformer tube after the inlet, to avoid damage from the burner flames.

The fins, extending in longitudinal direction of the reformer tubes, were disposed in such a way that there would be no shadowing effect from one fin to another, i.e. the minimal distance between two fins along the circumference of the tube was at least equal to the width of the fin.

The fins were distributed heterogeneously along the circumference, primarily in the region where the tubes face each other, which is where the tube wall temperature is the lowest (see FIG. 4), and away from the portion of the tubes facing the burners. As mentioned before, this setup provides a significant increase in heat flux while limiting the increase in the tube wall temperature, so that the tube thickness does not need to be increased, which would be detrimental to the costs and efficiency of the reformer.

In the following, the design of the fins is given for each of the tables.

Tables 1a, 1b and 2—single pass tubes—low steam export (Table 1a and 1b) and high steam export (Table 2)
Fins dimensions:
5 mm (t)×20 mm (w)×500 mm (l);
Number of fins:
8 along circumference, disposed as 4 on each side facing another tube, with a spacing of at least 20 mm across the circumference between 2 fins, and 21 segments of 500 mm along length of tube (for a total of 10.5 m), with no fins in 1^{st} meter after the inlet (to avoid damage from the burner flames);
Tube inner diameter:
4 inch=101.6 mm, tube thickness 8.5 mm, external diameter=118.6 mm;
Tube external surface=4.471 m²
Fins external surface per tube=8×10.5 m×(20 mm+5 mm)=2.100 m²
Increase of external surface=47.0%

TABLE 1a

| | Low steam export SMR - single pass tube configuration | | | | | | |
|---|---|---|---|---|---|---|---|
| | Comparative examples | | | | | | |
| | comp. | comp. | comp. | comp. | comp. | comp. | comp. |
| | example | example | example | example | example | example | example |
| | 1a | 1b | 1c | 1d | 1e | 1f | 1g |
| Setup | catalyst | catalyst | catalyst | catalyst | structured | structured \| | structured |
| | pellets | pellets + | pellets + | pellets + | catalyst | catalyst | catalyst |
| | | tubes | tubes | tubes | | | |
| | | with fins | with fins | with fins | | | |
| Maximum | 921 | 921 | 921 | 921 | 921 | 921 | 921 |
| tube wall | | | | | | | |
| temperature | | | | | | | |
| [° C.] | | | | | | | |
| Heat flux | 98 | 99 | 118 | 137 | 99 | 118 | 138 |
| [kW/m2] * | | | | | | | |
| Normalized | 1.80 | 1.74 | 2.14 | 2.55 | 1.75 | 2.12 | 2.52 |
| space | | | | | | | |
| velocity at | | | | | | | |
| SMR inlet | | | | | | | |
| [Nm3/s/m3] | | | | | | | |
| CH4 | 79.4 | 82.8 | 80.5 | 77.9 | 82.5 | 81.0 | 79.0 |
| conversion | | | | | | | |
| [%]** | | | | | | | |
| Reformer | 47.6 | 50.0 | 48.6 | 47.3 | 48.5 | 47.0 | 45.5 |
| efficiency | | | | | | | |
| (%) | | | | | | | |
| No of tubes | 100.0 | 100.0 | 83.3 | 71.4 | 100.0 | 83.3 | 71.4 |
| in reformer*** | | | | | | | |
| Total NG | 100.0 | 99.3 | 99.8 | 100.3 | 99.4 | 99.7 | 100.1 |
| consumption | | | | | | | |
| (feed + fuel)*** | | | | | | | |
| pressure | 2.45 | 2.37 | 3.43 | 4.72 | 2.37 | 3.40 | 4.65 |
| drop [bar] | | | | | | | |
| reformer | 19.4 | 21.1 | 14.2 | 10.0 | 20.5 | 13.8 | 9.8 |
| efficiency/ | | | | | | | |
| pressure | | | | | | | |
| drop | | | | | | | |
| (KPI 1) | | | | | | | |
| reformer | 47.6 | 50.0 | 58.3 | 66.2 | 48.5 | 56.4 | 63.7 |
| efficiency/ | | | | | | | |
| no. of tubes | | | | | | | |
| (KPI 2) | | | | | | | |

* Surface of fins not considered in calculation
**in reformer only, pre-reformer not considered
***Reference case value normalized at 100

(Specifications equally applicable for tables 1b, 2 and 3)

TABLE 1b
Low steam export SMR - single pass tube configuration

| | Examples (invention) | | | | |
|---|---|---|---|---|---|
| | example 1a | example 1b | example 1c | example 1d | example 1e |
| Setup | tubes with | tubes with | tubes with | tubes with | tubes with |
| | fins + | fins + | fins + | fins + | fins + |
| | structured | structured | structured | structured | structured |
| | catalyst | catalyst | catalyst | catalyst | catalyst |
| distribution of | hetero- | hetero- | hetero- | homo- | hetero- |
| fins | geneous | geneous | geneous | geneous | geneous |
| Maximum tube | 921 | 921 | 921 | 921 | 921 |
| wall | | | | | |
| temperature | | | | | |
| [° C.] | | | | | |
| Heat flux | 122 | 142 | 163 | 157 | 106 |
| [kW/m2] | | | | | |
| Normalized | 2.01 | 2.39 | 2.82 | 2.95 | 1.66 |
| space velocity | | | | | |
| at SMR inlet | | | | | |
| [Nm3/s/m3] | | | | | |
| CH4 conversion | 87.3 | 85.4 | 83.1 | 77.9 | 88.73 |
| [%] | | | | | |
| Reformer | 49.8 | 48.5 | 47.1 | 46.3 | 51.0 |
| efficiency (%) | | | | | |
| No of tubes in | 83.3 | 71.4 | 61.9 | 61.9 | 100 |
| reformer | | | | | |
| Total NG | 98.5 | 99.3 | 99.4 | 100.3 | 98.2 |
| consumption | | | | | |
| (feed + fuel) | | | | | |
| pressure drop | 3.19 | 4.37 | 6.10 | 6.10 | 2.24 |
| [bar] | | | | | |
| reformer | 15.6 | 11.1 | 7.7 | 7.6 | 22.8 |
| efficiency/ | | | | | |
| pressure drop | | | | | |
| (KPI 1) | | | | | |
| reformer | 59.8 | 68.0 | 76.1 | 74.8 | 51.0 |
| efficiency/no. | | | | | |
| of tubes | | | | | |
| (KPI 2) | | | | | |

TABLE 2
High steam export SMR - single pass tube configuration

| | comparative examples | | | | examples | |
|---|---|---|---|---|---|---|
| | comp. | comp. | comp. | comp. | (invention) | |
| | example | example | example | example | example | example |
| | 2a | 2b | 2c | 2d | 2a | 2b |
| Setup | catalyst | catalyst | catalyst | catalyst | tubes | tubes |
| | pellets | pellets + | pellets + | pellets + | with | with |
| | | tubes | tubes | tubes | fins + | fins + |
| | | with fins | with fins | with fins | structured | structured |
| | | | | | catalyst | catalyst |
| Maximum | 921 | 921 | 921 | 921 | 921 | 921 |
| tube wall | | | | | | |
| temperature | | | | | | |
| [° C.] | | | | | | |
| Heat flux | 107 | 109 | 130 | 150 | 156 | 116 |
| [kW/m²] | | | | | | |
| Normalized | 1.98 | 1.92 | 2.35 | 2.81 | 2.63 | 1.82 |
| space | | | | | | |
| velocity at | | | | | | |
| SMR inlet | | | | | | |
| [Nm³/(s*m³)] | | | | | | |
| Methane | 75.4 | 78.7 | 76.5 | 74.0 | 81.1 | 84.3 |
| (CH₄) | | | | | | |
| conversion/% | | | | | | |
| Reformer | 45.4 | 48.0 | 46.7 | 45.4 | 46.6 | 49 |
| efficiency/% | | | | | | |
| Number of | 100 | 100 | 83.3 | 71.4 | 71.4 | 100 |
| tubes in | | | | | | |
| reformer | | | | | | |
| (normalized) | | | | | | |
| Total NG | 100 | 99.6 | 100.1 | 100.6 | 99.5 | 98.5 |
| consumption | | | | | | |
| (process gas | | | | | | |
| and fuel gas) | | | | | | |
| pressure | 2.55 | 2.46 | 3.57 | 4.91 | 4.53 | 2.33 |
| drop [bar] | | | | | | |
| reformer | 17.8 | 19.5 | 13.1 | 9.2 | 10.3 | 21.0 |
| efficiency/ | | | | | | |
| pressure | | | | | | |
| drop (KPI 1) | | | | | | |
| reformer | 45.4 | 48.0 | 56.0 | 63.5 | 65.2 | 49.0 |
| efficiency/no. | | | | | | |
| of tubes | | | | | | |
| (KPI 2) | | | | | | |

Table 3—tube-in-tube configuration of reformer tube

### Examples 3a and 3b

Fins dimensions:
5 mm (t)×20 mm (w)×500 mm (l)
Number of fins:
8 along circumference, disposed as 4 on each side facing another tube, with a spacing of at least 20 mm across the circumference between 2 fins, and 21 segments of 500 mm along length of tube (for a total of 10.5 m), with no fins in 1^{st} 1 m after the inlet
Tube inner diameter:
5 inch=127 mm, tube thickness 15.5 mm, external diameter=158 mm
Tube external surface=5.956 m 2
Fins external surface per tube=8×10.5 m×(20 mm+5 mm)=2.100 m²
Increase of external surface=35.3%

TABLE 3
Low steam export SMR - tube-in-tube configuration

| | Comparative examples | | | | | |
|---|---|---|---|---|---|---|
| | compara. | compara. | compara. | compara. | Invention | |
| | example | example | example | example | example | example |
| | 3a | 3b | 3c | 3d | 3a | 3b |
| Setup | catalyst | structured | structured | structured | tubes | tubes |
| | pellets | catalyst | catalyst | catalyst | with | with |
| | | | | | fins + | fins + |
| | | | | | structured | structured |
| | | | | | catalyst | catalyst |
| Maximum tube | 921 | 921 | 921 | 921 | 921 | 921 |
| wall | | | | | | |
| temperature [° C.] | | | | | | |
| Heat flux [kW/m²] | 66 | 68 | 101 | 132 | 102 | 137 |
| Normalized space | 1.09 | 1.02 | 1.61 | 2.34 | 1.55 | 2.14 |
| velocity at SMR | | | | | | |
| inlet [Nm³/(s*m³)] | | | | | | |
| Methane (CH₄) | 79.3 | 85.5 | 80.3 | 76.3 | 82.7 | 80.8 |
| conversion/% | | | | | | |
| Reformer | 59.2 | 60.8 | 57.2 | 52.7 | 59.8 | 56.7 |
| efficiency/% | | | | | | |
| Number of tubes | 100.0 | 100.0 | 66.7 | 50.0 | 66.7 | 50.0 |
| in reformer | | | | | | |
| (normalized) | | | | | | |
| Total natural gas | 100.0 | 99.1 | 99.4 | 100.8 | 98.9 | 99.3 |
| consumption | | | | | | |
| (process gas and | | | | | | |
| fuel gas) | | | | | | |
| reformer | 59.2 | 60.8 | 85.8 | 105.4 | 89.7 | 113.4 |
| efficiency/No. of | | | | | | |
| tubes | | | | | | |
| (KPI 2) | | | | | | |

For the sake of comparability, each individual case within the same simulation type (low steam export single pass; high steam export single pass; tube-in-tube configuration) was designed such that the same amount of hydrogen and export steam is produced. Furthermore, the simulations were carried out in such a way that the same maximum wall temperature of a reformer tube, in this case 921° C., is obtained for each case.

For all examples according to the invention (setup with structured catalyst and fin) a heterogeneous distribution of fins along the circumferential surface of a reformer tube is assumed, with the exception of example 1d. According to example 1d, the fins are uniformly or homogeneously distributed along the circumferential surface of a reformer tube.

Table 1a shows the results of the simulations for comparative examples according to the respective setup mentioned in the table (low steam export SMR; single pass tube configuration; catalyst pellets 1a; catalyst pellets and tubes with fins 1b-1d; structured catalyst without fins 1f+1g). All comparative examples involving fins used the advantageous heterogeneous distribution of the fins to limit the increase in maximum wall temperature.

Table 1b shows the results of the simulations for examples according to the invention and the respective setup mentioned in the table (low steam export SMR; single pass tube configuration; structured catalyst with fins 1a-1e, for 1d with homogeneous distribution of the fins, otherwise heterogeneous distribution).

Table 2 shows the results of the simulations for comparative examples and examples according to the invention and the respective setup mentioned in the table (high steam export SMR; single pass configuration; catalyst pellets comparative example 2a; catalyst pellets with tubes with fins comparative examples 2b-2d; structured catalyst and tubes with fins examples 2a+2b).

Table 3 shows the results of the simulations for comparative examples and examples according to the invention and the respective setup mentioned in the table (low steam export SMR; tube-in-tube configuration; catalyst pellets comparative example 3a; structured catalyst comparative examples 3b-3d; structured catalyst and tubes with fins examples 3a+3b).

The tables 1a, 1b, 2 and 3 show the synergistic effects of using a combination of a surface-enlarging element, such as fins, on the reformer tube and the simultaneous use of a structured catalyst. The non-inventive comparative examples show performance parameters of reformer tubes with either catalyst pellets and reformer tubes with or without fins, or with structured catalyst and reformer tubes without fins.

Tables 1a and 1b refer to a low steam export steam methane reforming case with single pass tube configuration (as shown in FIG. 1), for instance in Western Europe, with relatively expensive natural gas. Table 2 refers to a high steam export steam methane reforming case with single pass tube configuration, for instance on the US Gulf coast, with relatively inexpensive natural gas. Table 3 refers to a steam methane reforming case with tube-in-tube configuration (as shown in FIGS. 2 and 3) and low steam export. The process gas is first reformed in the outer tube, and the reformed gas then flows back through the inner tube and exchanges heat counter-currently with the feed gas. Therefore, the heat for the reactions comes from the combustion chamber of the steam reformer as well as the reformed gas flowing in the inner tube.

A setup with reformer tubes with surface-enlarging elements, such as fins, will yield a reformer efficiency comparable to that of a conventional design (without fins), albeit with fewer tubes, thereby generating capital investment (CAPEX) savings. However, various adverse effects are observed, as fins are added to the reformer tubes and the number of tubes is decreased. For a given reformer duty and fewer tubes, the maximum wall temperature increases, which may impact the lifetime of the reformer tubes. The mass flux per tube increases, with the consequence that the pressure drop and approach to equilibrium increase.

As external fins are added to reformer tubes with catalyst pellets (see comparative examples 1a and 1b; comparative examples 2a and 2b), the higher heat exchange surface leads to a higher reformer efficiency and lower natural gas consumption (comparative example 1 b; comparative example 2b). As the number of reformer tubes is decreased (comparative examples 1c and 1d; comparative examples 2c and 2d), the additional surface of the fins offsets the decrease in the number of tubes, with the consequence that the natural gas consumption stays largely unchanged relative to the reference comparative cases 1a and 2a. The smaller steam methane reformer, i.e. the steam methane reformer with fewer tubes, has a higher impact on the production price of Hydrogen in the scenario of Table 2 (US gulf coast), where natural gas is cheaper and the weight of capital investment in the price of Hydrogen is more pronounced.

In comparative cases 1c and 2c, the increase in maximum wall temperature must be addressed. One solution would consist in increasing the reformer tube wall thickness. In typical cost-efficient reformer designs, however, the maximum tube wall thickness has already been reached. The reforming temperature must then be reduced to avoid exceeding design limits on the maximum wall temperature, which in turn affects the thermodynamic equilibrium of the reforming reaction adversely and limits the reformer efficiency. As the number of tubes is further decreased (comparative examples 1d and 2d), the reforming temperature must be decreased further until the reformer efficiency falls beneath or is equal to that of the reference comparative examples 1a and 2a. The capital investment savings linked to a reformer with fewer tubes now need to be weighed against an increase in natural gas consumption.

For a given reformer size and number of tubes, a design with structured catalyst will yield a slight improvement in reformer efficiency over a conventional design with catalyst pellets.

As structured catalyst is substituted for conventional pellets (comparative example 1e; comparative example 3b), the reformer efficiency increases, with a corresponding reduction in natural gas consumption. Similarly to a design of reformer tubes with fins, however, the benefits of structured catalyst are maximized by reducing the number of tubes in the reformer and aiming for a reformer efficiency close to that of the conventional design, which results in capital savings (comparative example if; comparative example 3c). As the number of tubes is decreased, the maximum wall temperature increases. The reforming temperature must once again be decreased to avoid exceeding design limits on the maximum wall temperature, which affects the thermodynamic equilibrium of the reforming reaction adversely and leads to a higher consumption of natural gas. As the natural gas in the feed increases, so does the pressure drop. As the number of reformer tubes is decreased under a certain limit (comparative example 1g; comparative example 3d), the heat transfer benefits from the structured catalyst no longer compensate the loss in heat exchange surface from the reduction in number of tubes. The reformer efficiency decreases significantly, with the consequence that the natural gas consumption increases sharply and is now higher than for the reference comparative cases 1a and 3a. At the same time, the additional heat available in the flue gas of the reformer leads to higher steam production. If it is assumed that the steam export capacity is constrained by local requirements the steam-to-carbon ratio or some other plant parameter have to be modified compared to the reference comparative cases 1a and 3a. This leads to a further degradation of plant economics. The steam-to-carbon ratio is defined as the molar ratio of steam to carbon excluding carbon from carbon monoxide and carbon dioxide.

Enlarging the outer surface of reformer tubes, for example with fins, helps overcome the heat transfer resistance from the combustion chamber of a steam reforming furnace to the reformer tubes. Structured catalysts help to overcome the internal heat transfer resistance in the tube. The combination of both features thus enhances both the external and internal heat transfer coefficients.

However, the synergistic effects of structured catalysts and tubes with enlarged outer surface go further. As noted above, and evidenced by comparative examples 1d and 2d, as fins are added to the reformer tubes and the number of reformer tubes is decreased, the wall temperature increases, with the consequence that the reforming temperature has to be decreased and the reaction equilibrium is degraded. The addition of structured catalyst yields higher heat transfer coefficients from the tube wall to the reforming gases, thereby providing a larger heat sink and reducing the tube temperature. Furthermore, the higher geometric surface area (GSA) and lower pressure drop of the structured catalyst allows to operate at higher mass flux while maintaining a reasonable conversion and pressure drop (comparative examples 1 d and 2d). The normalized space velocity in Tables 1a to 3 is defined as the normalized volume flow rate at 0° C. (zero degree Celsius) and 1 atmosphere, divided by the total volume of the reformer tube, i.e. reactor, filled with catalyst and including the space used by the catalyst. The increase in convection encourages the heat transfer further, and the increased amount of reaction provides a surprisingly even larger heat sink, which allows to increase the reforming temperature and recover a high reformer efficiency (example 1a; example 2) or to decrease the number of tubes further (example 1b), depending on the relative weights of natural gas and capital investment.

Conversely, starting with a design involving structured catalyst, and by decreasing the number of reformer tubes beyond a certain limit (comparative examples 3c and 3d), the loss in heat exchange surface becomes predominant, leading to a degradation of the reformer efficiency, and a corresponding increase in natural gas consumption. The addition of surface-enlarging elements, such as fins, enhances the reformer efficiency, resulting in more natural gas savings (example 3a versus comparative example 3c; or example 3b versus comparative example 3d), or allowing for a further decrease in reformer size whilst maintaining the natural gas consumption (example 3b versus comparative example 3c), depending on the relative weights of natural gas and capital investment.

By increasing the heat flux between the combustion chamber of the reforming reactor and the tubes, the surface-enlarging elements, such as fins, allow for a decrease in the number of tubes without compromising on the reformer efficiency or increasing the firing duty. The structured catalyst enhances the internal heat transfer and limits the wall temperature increase linked to the higher heat flux from the fins, thereby enabling to increase the reforming temperature or reduce the number of tubes in the reformer further. The combination of both surface-enlarging elements, such as fins, and structured catalyst yields synergies, allowing for a more compact and efficient reforming reactor, i.e. reformer, than with either surface-enlarging elements, such as fins, or structured catalyst only.

The synergistic effect based on the combination of structured catalyst and the use of fins is also illustrated by the following fact. As described above, the performance of the reforming reactor can be very well described by two different key performance indicators. One is the quotient of the reformer efficiency and the pressure drop (hereinafter referred to as “KPI 1”) and the other is the quotient of the reformer efficiency and the number of reformer tubes in the reforming reactor (hereinafter referred to as “KPI 2”). If one compares the respective comparative examples with the examples according to the invention for the same number of reformer tubes in the reforming reactor, it can be seen that the two KPIs are higher in each case when a combination of structured catalyst and fins is used. For example, KPI 1 according to example 1a (number of tubes normalised 83.3) is 15.6, while KPI 1 according to comparative Example 1c (fins and catalyst pellets) is only 14.2 and according to comparative Example 1f (structured catalyst, no fins) is only 13.8. KPI 2 according to Example 1a is 59.8, while KPI 2 according to Comparative Example 1c (fins and catalyst pellets) is only 58.3 and according to Comparative Example 1f (structured catalyst, no fins) is only 56.4. The same observation results from the comparison of Example 1 b (number of tubes normalised 71.4) with KPI 1=11.1 and KPI 2=68.0 and Comparative Examples 1d with KPI 1=10.0 and KPI 2=66.2 and 1g with KPI 1=9.8 and KPI 2=63.7. This observation can be transferred to all other cases in tables 1a, 1b, 2 and 3 with the appropriate adjustments. In all cases, the combination of structured catalyst and fins with the same number of tubes results in a higher KPI 1 and KPI 2. The synergistic effect from the use of surface-enlarging elements and structured catalyst established according to the invention therefore enables the construction of more compact reforming reactors with a reduced number of reformer tubes with the same efficiency.

However, further unexpected effects can be derived from the data in the tables. In Table 1 b, only example 1e has a normalised space velocity below 2 Nm³/s/m³. In examples 1a to 1d, the normalised space velocities are in the range of approximately 2 to 3. KPI 1 is higher in example 1e than in examples 1a to 1d, but KPI 2 in example 1e is lower than in all examples 1a to 1d. This is because the high pressure drop according to examples 1a to 1d, which is reflected in KPI 1, is significantly overcompensated by a resulting higher KPI 2 due to the drastically reduced number of reformer tubes in examples 1a to 1d compared to example 1e. Also, most of the performance data in examples 1a to 1d (natural gas consumption, natural gas conversion, etc.) are comparable to the performance data of example 1e. Thus, it is surprisingly found that by setting comparatively high space velocities and simultaneously using structured catalyst and fins, the number of reformer tubes in the reforming reactor can be drastically reduced without any loss in the key performance data of the reforming reactor. The same observations can be made for the cases in Table 2. KPI 1 is lower in the case of example 2a (normalised space velocity above 2) than in the case of example 2b (normalised space velocity below 2). However, this effect is overcompensated by the significantly higher KPI 2 of example 2a, as the number of reformer tubes was reduced by 28.6% according to this example compared to example 2b. The same observation can be made with the corresponding adjustments for examples 3a and 3b of Table 3.

Another surprising effect can be derived from the comparison of examples 1c and 1d. The arrangement of the fins according to example 1c corresponds to a heterogeneous distribution as showed in and described for FIG. 4. The arrangement of the fins according to example 1d corresponds to a homogeneous distribution, whereby the number of fins corresponds to the number according to example 1c and the fins have the same surface area, but the distribution of the fins along the circumferential surface of the reformer tube is uniform with equal spacing between them. KPI 1 and KPI 2 are both higher for the same number of reformer tubes in examples 1c and 1d, but with heterogeneous arrangement of fins according to example 1c. The heterogeneous arrangement of the fins thus enables further optimisation of the reforming reactor with regard to its efficiency and the possibility of building the most compact reformers possible.

### LIST OF REFERENCE SIGNS

100 reformer tube with fins
101 reformer tube
102 fin
200 reformer tube with fins
201 outer reformer tube
202 inner reformer tube
203 fin
204 rod
400 section of reforming reactor
401a, 401b, 401c burner
402a, 402b reformer tube with fins
403 fin
404a, 404b, 404c burner
405 first partial (circumferential) surface
406 second partial (circumferential) surface

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-23. (canceled)

24. A reforming reactor for an endothermic process, the reforming reactor comprising: a plurality of reformer tubes allowing a flow of hydrocarbons and at least one further fluid inside the tubes,
wherein the reformer tubes contain in their interior a catalyst for the conversion of said hydrocarbons and said at least one further fluid to synthesis gas;
means for heating the reformer tubes,
wherein at least a portion of the plurality of reformer tubes is provided with one or more elements for enlarging the outer surface area of a reformer tube, and
the catalyst comprises a structured catalyst.

25. The reforming reactor according to claim 24, wherein the reforming reactor is configured such that a normalized space velocity at an inlet of a reformer tube is from 1 Nm³/(s*m³) to 5 Nm³/(s*m³).

26. The reforming reactor according to claim 24, wherein the reforming reactor is configured such that a normalized space velocity at an inlet of a reformer tube is from 1.9 Nm³/(s*m³) to 3.2 Nm³/(s*m³).

27. The reforming reactor according to claim 24,
wherein the means for heating the reformer tubes are burners,
wherein the reformer tubes are arranged in rows within the reforming reactor, each row of reformer tubes thereby defining a reformer tube row,
wherein the burners are arranged in rows within the reforming reactor,
wherein a plurality of inner burners is arranged between and parallel to two reformer tube rows, thereby defining an inner burner row, and
wherein a plurality of outer burners is arranged between and parallel to a reformer tube row and a reforming reactor wall, thereby defining an outer burner row.

28. The reforming reactor according to claim 27,
wherein the elements for enlarging the outer surface area of a reformer tube are distributed heterogeneously along the circumference of a reformer tube,
wherein the circumferential surface of a reformer tube has a first partial surface and a second partial surface,
wherein the first partial surface corresponds to the surface with which reformer tubes within a reformer tube row face one another, and the second partial surface corresponds to the surface with which reformer tubes face a row of inner burners or a row of outer burners, and
wherein the number of elements for enlarging the outer surface of a reformer tube arranged on the first partial surface is larger than the number of elements for enlarging the outer surface of a reformer tube arranged on the second partial surface.

29. The reforming reactor according to claim 24,
wherein the structured catalyst is selected from the group consisting of monoliths, open cell foams, stacked wire meshes and structured packing.

30. The reforming reactor according to claim 24,
wherein the structured catalyst comprises a supporting structure and a catalytic active species fixed to said supporting structure.

31. The reforming reactor according to claim 24,
wherein a flowed-through area of the reformer tube comprises a circular cross-section or an annular cross-section.

32. The reforming reactor according to claim 24,
wherein the structured catalyst comprises one type of structured catalyst or a plurality of structured catalysts within the same reformer tube.

33. The reforming reactor according to claim 24,
wherein an element for enlarging the outer surface area of the reformer tube is made from the same material as the reformer tube.

34. The reforming reactor according to claim 24,
wherein an element for enlarging the outer surface of the reformer tube is substance bonded to the material of the reformer tube.

35. The reforming reactor according to claim 24,
wherein an element for enlarging the outer surface area of the reformer tube is selected from at least one element of the group consisting of fins, blades, rips, slats and lamellae.

36. The reforming reactor according to claim 35,
wherein the element for enlarging the outer surface area of the reformer tube is a fin.

37. The reforming reactor according to claim 24,
wherein an element for enlarging the outer surface area of the reformer tube extends in the longitudinal direction of the reformer tube.

38. The reforming reactor according to claim 24,
wherein the number of elements for enlarging the outer surface area of the reformer tube is larger in the area of the inlet of the reformer tube than in the area of the outlet of the reformer tube.

39. The reforming reactor according to claim 24,
wherein the number of elements for enlarging the outer surface area of the reformer tube on the circumference at any height along the reformer tube is comprised between 0 (zero) and 50.

40. The reforming reactor according to claim 24,
wherein the heat flux from an outer part of the reformer tubes to an inner part of the reformer tubes is from 50 kW/m² to 200 kW/m² on average along the length of the tube.

41. The reforming reactor according to claim 24,
wherein the reformer tube provided with one element or a plurality of elements for enlarging the outer surface area of said reformer tube comprises an outside surface area which is at least 10% to 60% higher than a comparable reformer tube without elements for enlarging the outer surface area.

42. An endothermic process for the production of synthesis gas, comprising:
allowing a flow of hydrocarbons and at least one further fluid inside a plurality of reformer tubes,
whereby the reformer tubes contain in their interior a catalyst for the conversion of said hydrocarbons and said at least one further fluid to synthesis gas;
heating the plurality of reformer tubes to convert said hydrocarbons and said at least one further fluid to synthesis gas;
wherein at least a portion of the plurality of reformer tubes is provided with one or more elements for enlarging the outer surface area of a reformer tube, and
the catalyst comprises a structured catalyst.

43. The endothermic process according to claim 42,
wherein a normalized space velocity at an inlet of a reformer tube is from 1 Nm³/(s*m³) to 5 Nm³/(s*m³).
